(19) United States
(12) Patent Application Publication
(10) Pub. No.: US 2014/0049384 A1
(43) Pub. Date: Feb. 20, 2014

(54) METHOD FOR WARNING A FOLLOWING MOTOR VEHICLE

(71) Applicant: GM GLOBAL TECHNOLOGY OPERATIONS LLC, Detroit, MI (US)

(72) Inventor: Timo MUELLER, Limburg (DE)

(73) Assignee: GM GLOBAL TECHNOLOGY OPERATIONS LLC, Detroit, MI (US)

(21) Appl. No.: 13/966,466

(22) Filed: Aug. 14, 2013

(30) Foreign Application Priority Data
Aug. 16, 2012 (DE) 10 2012 016 255.3

(51) Int. Cl. B60Q 9/00

(52) U.S. Cl. CPC B60Q 9/008
USPC 340/435

(57) ABSTRACT

A method is provided for warning a following motor vehicle through a motor vehicle travelling ahead, in which a distance between the motor vehicle travelling ahead and the motor vehicle following is measured and compared with a safety distance, which is dependent on a travelled speed of the motor vehicle travelling ahead and when the measured distance undershoots this safety distance, a warning signal is emitted by the motor vehicle travelling ahead to the following motor vehicle. An apparatus is also provided for warning a following motor vehicle through a motor vehicle travelling ahead.

### CROSS-REFERENCE TO RELATED APPLICATION

This application claims priority to Patent Application No. 10 2012 016 255.3, filed Aug. 16, 2012, which is incorporated herein by reference in its entirety.

### TECHNICAL FIELD

The technical field relates to the technical area of the road safety of a motor vehicle and in particular to a method for warning a following motor vehicle through a motor vehicle travelling ahead.

### BACKGROUND

One of the most frequent reasons for accidents is driving up too closely without keeping the safety distance. This is partly done by aggressive drivers, but partly also through incorrect estimation of the road users. The road users are unable to translate the regulations regarding travelling distances of the Road Traffic Act into the reality or cannot correctly estimate distances unconditionally. German Publication DE 11 2009 000 109 T5 discloses a belt tensioning system, which is activated as a function of the signals of a front, side and rear radar.

At least one of object is solving the aforementioned problems and increasing the road safety of a motor vehicle against rear-end collisions in a simple and reliable manner. In addition, other objects, desirable features and characteristics will become apparent from the subsequent summary and detailed description, and the appended claims, taken in conjunction with the accompanying drawings and this background.

### SUMMARY

A method is provided for warning a following motor vehicle through a motor vehicle travelling ahead is accordingly provided, in which a distance between the motor vehicle travelling ahead and the following motor vehicle is measured and compared with a safety distance, which is dependent on a speed travelled by the motor vehicle travelling ahead and if the measured distance undershoots this safety distance, a warning signal to the following motor vehicle is output by the motor vehicle travelling ahead. The following driver is thus given an indication when the safety distance is not adequate. Accidents can thus be prevented and accidental consequences reduced. As a consequence, there are fewer traffic fatalities, fewer insurance damages and less congestion.

In another embodiment, a method is provided with a connection between the travelled speed and the safety distance that is dependent on the speed is preset. Thus, a travelling speed-dependent safety distance can be set, which corresponds to the individual safety need of a respective driver. Here, limits can be provided within which the safety distance can be selected.

In a further embodiment, it is provided that the warning signal is preset as a visual and/or acoustic signal and/or as a radio signal. A visual signal in this case can be output by the lights already present at the rear of a motor vehicle, but alternatively or additionally also by an individual light source. The same applies mutatis mutandis to an acoustic signal. When motor vehicles in the future are equipped with Car-to-Car communication, the following motor vehicle or its driver can also be informed via Car2Car, i.e., via a radio signal, that the safety-distance is not adequate. This can, for example, trigger a corresponding indication on the instrument panel or similar and/or automatic braking.

The described methods are provided in a safety system of a motor vehicle, in particular in its control unit. The control unit can have a digital microprocessor unit (CPU) that is data-connected to a storage system and a bus system, a working memory (RAM) and storage. The CPU is designed to execute commands, which are embodied as a program stored in a storage system, to capture input signals from the data bus and to emit output signals to the data bus. The storage system can have different storage media such as optical, magnetic, solid-state and other non-volatile media, on which a corresponding computer program for carrying out the method and the advantageous configurations is stored. The program can be of such a type that it embodies or is able to carry out the methods described here, so that the CPU can carry out the steps of such methods and thereby control the motor vehicle.

For carrying out the method, a computer program that comprises a program code is suitable in order to carry out all steps of any of the claims when the program is executed on a computer. The computer program can be read into already existing control units and used in order to control an apparatus for emitting a warning signal from a motor vehicle travelling ahead to a following motor vehicle.

Provided for this is a computer program product with program code that are stored on a computer-readable data carrier in order to carry out the foregoing and subsequently described methods. The computer program product can be integrated in control units as a retrofit option.

In the following, an apparatus for warning a following motor vehicle from a motor vehicle travelling ahead is described, which embodies the advantages of the above method. The apparatus for warning a following motor vehicle through a motor vehicle travelling ahead, includes, but is not limited to for a measuring device to measure a distance between the motor vehicle travelling ahead and the following motor vehicle and with a comparison device for comparing this measured distance with a safety distance, which is dependent on a speed travelled by the motor vehicle travelling ahead, and with a emitting device for emitting a warning signal from the motor vehicle travelling ahead to the following motor vehicle when the measured distance undershoots this safety distance. The following driver is also given an indication through this when the safety distance is not maintained. Thus, accidents can be prevented and accidental consequences reduced. As a consequence, there are fewer road fatalities, fewer insurance damages and less congestion.

In a further embodiment it is provided that a connection between the travelled speed and the safety distance that is dependent on the former can be influenced. In this way, an individual safety need of a driver can be taken into account.

In a further embodiment, it is provided that the warning signal comprises a visual and/or acoustic signal and/or a radio signal. Thus, a reliable transmission of the warning is possible, in particular under difficult weather conditions. In a further embodiment, the warning signal comprises a light projection onto the road between the motor vehicles. The warning signal thereby appears in the direct field of vision of the driver of a following vehicle without dazzling said driver. Such a light projection can be based on laser light, but also utilize polychromatic, incoherent light. Substantial is a good detectability of different road surfaces and under difficult weather conditions.

In a further embodiment, it is provided that the light projection comprises a warning triangle and/or the indication of a safety distance. Such a representation can be quickly and intuitively comprehended by a following driver since he already knows such symbols from corresponding road signs or indications.

In a further embodiment, a measuring device is provided for measuring the distance is embodied as a rear-end radar. Since corresponding front radars are already in use, these would merely have to be employed at the rear, which makes possible a particularly simple provision.

### BRIEF DESCRIPTION OF THE DRAWINGS

The present invention will hereinafter be described in conjunction with the following drawing figures, wherein like numerals denote like elements, and:

FIG. 1 a block diagram of a method according to an embodiment;

FIG. 2 a vehicle with an apparatus according to an embodiment; and

FIG. 3 a control unit for carrying out the method according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

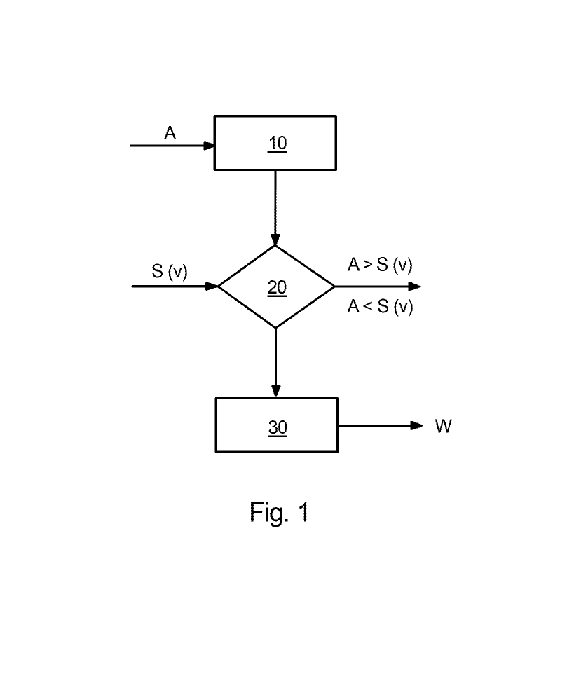

FIG. 1 shows a block diagram of a method according to an embodiment. A distance A between a motor vehicle travelling ahead and a motor vehicle following is measured through a measuring device 10, which in this case is to be formed as a rear-end radar. The distance A is passed on to a comparison device 20 for comparing this distance A with a safety distance S, which in turn is dependent on a travelling speed v. Here it is true that the safety distance S has to be the greater, the greater the travelling speed v is. However, the safety distance S can be set in certain limits, i.e., it can also be selected greater than a minimum safety distance S in order to take into account an individual safety need of a driver. When the comparison device 20 detects that the safety distance S is undershot by the actually existing distance A, it activates the emitting device 30 for emitting a warning signal W. Here, this warning signal is to be projected onto the road between the two motor vehicles so that the driver of the following motor vehicle can reduce his current speed and again increase his distance to the motor vehicle travelling ahead.

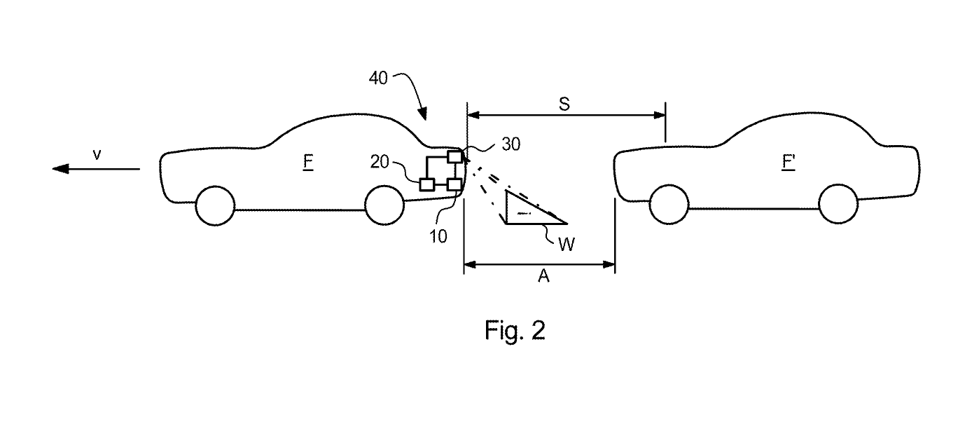

FIG. 2 shows a vehicle F with an apparatus 40 according to an embodiment, which comprises a measuring device 10 for measuring a distance to a following motor vehicle F′, a comparison device 20 for comparing the distance with a travelling speed-dependent safety distance and an emitting device 30 for emitting a warning signal W. In the present case, this safety distance S to the motor vehicle travelling ahead has already been undershot by the motor vehicle F′, so that a warning triangle is projected onto the road located between the vehicles F, F′. When the motor vehicle F′ again keeps the require safety distance S, this projection is extinguished. Because of this, the driver of the motor vehicle F′ is visually held to observing the safety distance S at a certain speed v. In principle, the warning signal W however can be transmitted alternatively or additionally via a Car-to-Car communication and appear, for example, on the instrument panel of the following motor vehicle F′ and/or be output there as an acoustic signal.

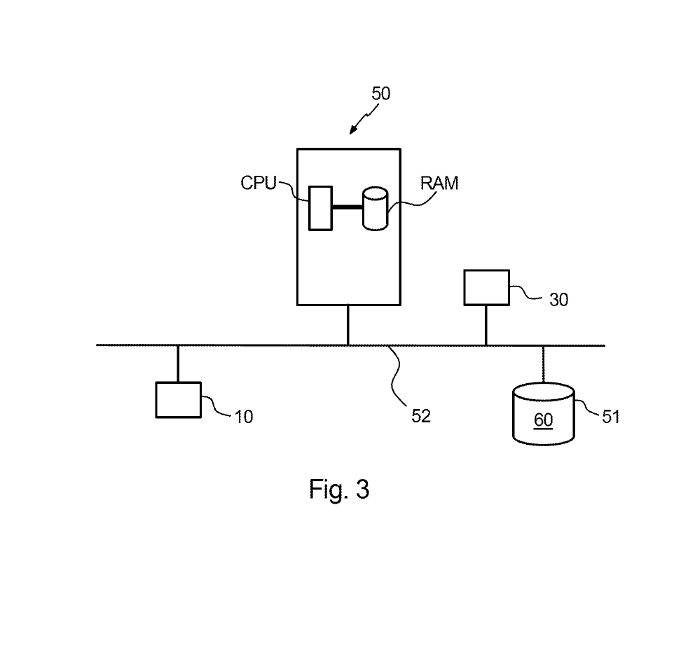

FIG. 3 shows a control unit 50 for carrying out the method according to an embodiment, which for example can be realized in the apparatus 40 of FIG. 2, and which comprises a CPU and a working memory RAM. The CPU is designed to execute commands that are embodied as a program 70 stored in a storage system 51, to capture input signals from the data bus 52 and emit output signals to the data bus 52. A distance (A) determined by the measuring device 10 for measuring can be signaled to the control unit 50 via the data bus 52, which control unit in turn activates the emitting device 30 for emitting the warning signal W when a travelling speed-dependent safety distance S is undershot.

The storage system 51 can have different storage media such as optical, magnetic, solid-state and other non-volatile media, on which a corresponding computer program 70 for carrying out the method and the advantageous configurations is stored. The program 70 can be of such a type that it embodies or is able to carry out the method described here, so that the CPU can execute the steps of such methods and thereby control an apparatus for emitting a warning signal from a motor vehicle.

Suitable for carrying out the method is a computer program 70, which comprises program code in order to carry out all steps from any of the claims when the program 70 is executed on a computer. The computer program 70 can be read in and used in already existing control units with simple device in order to realize an apparatus for warning a following motor vehicle through a motor vehicle travelling ahead.

Provided for this is a computer program product with program code, which are stored on a computer-readable data carrier in order to carry out the method when the program product is executed on a computer. The computer program product can also be integrated in control units as retrofit option. Altogether, a method and an apparatus are created that increase the road safety of a motor vehicle against rear-end collisions in a simple and reliable manner.

Although in the preceding description some possible embodiments were disclosed it is to be understood that numerous further variants of embodiments exist through combination possibilities of all features and embodiments mentioned and furthermore technically obvious to the person skilled in the art. It is to be understood, furthermore, that the exemplary embodiments are to be explained merely as examples that do not restrict the scope of protection, the applicability and the configuration in any way. The preceding description is rather intended to show the person skilled in the art a suitable way of realizing at least one exemplary embodiment. It is to be understood that in an exemplary embodiment numerous changes with respect to function and arrangement of the elements can be carried out without leaving the scope of protection disclosed in the claims and equivalents.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method of a first motor vehicle warning a second motor vehicle following the first motor vehicle, comprising:
measuring a distance (A) between the first motor vehicle and the second motor vehicle;
comparing the distance (A) compared a safety distance (S) that is at least dependent on a travelled speed (v) of the first motor vehicle; and
a warning signal (W) by the first motor vehicle when the safety distance (S) is undershot by the distance (A).

2. The method according to claim 1, further comprising presetting a connection between the travelled speed (V) and the safety distance (S).

3. The method according to claim 1, wherein the warning signal (W) is a visual signal.

4. (canceled)

5. A non-transitory computer readable medium embodying a computer program product, said computer program product comprising:
a warning program for a first motor vehicle warning a second motor vehicle following the first motor vehicle, the warning program configured to:
measure a distance (A) between the first motor vehicle and the second motor vehicle;
compare the distance (A) with a safety distance (S) that is at least dependent on a travelled speed (v) of the first motor vehicle; and
a warning signal (W) by the first motor vehicle when the safety distance (S) is undershot by the distance (A).

6. An apparatus for a first motor vehicle warning a second motor vehicle following the first motor vehicle, comprising:
with a measuring device that is configured to measure a distance (A) between the first motor vehicle and the second motor vehicle;
a comparing device that is configured to compare the distance (A) with a safety distance (S) that is dependent on a travelled speed (v) of the first motor vehicle; and
an emitting device that is configured to emit a warning signal (W) from the first motor vehicle to the second motor vehicle when the safety distance (S) is undershot by the distance (A).

7. The apparatus according to claim 6, wherein a connection between the travelled speed (v) and the safety distance (S) is influenced.

8. The apparatus according to claim 6, wherein the warning signal (W) comprises a visual.

9. The apparatus according to claim 8, wherein the warning signal (W) comprises a light projection onto a road between the first motor vehicle and the second motor vehicle.

10. The apparatus according to claim 9, wherein the light projection comprises a warning triangle.

11. The apparatus according to claim 6, wherein the measuring device is a rear-end radar.

12. The method according to claim 1, wherein the warning signal (W) is an acoustic signal.

13. The method according to claim 1, wherein the warning signal (W) is a radio signal.

14. The non-transitory computer readable medium embodying the computer program product of claim 5, said warning program further configured to receive a preset connection between the travelled speed (V) and the safety distance (S).

15. The non-transitory computer readable medium embodying the computer program product of claim 5, wherein the warning signal (W) is an acoustic signal.

16. The non-transitory computer readable medium embodying the computer program product of claim 5, wherein the warning signal (W) is a radio signal.

17. The non-transitory computer readable medium embodying the computer program product of claim 5, wherein the warning signal (W) is an acoustic signal.

18. The apparatus according to claim 6, wherein the warning signal (W) comprises a radio signal.

19. The apparatus according to claim 6, wherein the warning signal (W) comprises an acoustic signal.

20. The apparatus according to claim 6, wherein the warning signal (W) comprises an acoustic signal.
